(19) United States
(12) Patent Application Publication
(10) Pub. No.: US 2010/0289486 A1
(43) Pub. Date: Nov. 18, 2010

(54) DEVICE FOR THE DETECTION OF AN ACTUATION ANGLE OF AN ELEMENT ROTATABLE ABOUT A SHAFT

(75) Inventors: Joerg Ehlebrecht, Berlin (DE); Thomas Luedtke, Berlin (DE); Henning Koschke, Berlin (DE); Christian Buchold-Tomazic, Oranienburg (DE)

Correspondence Address: PEPPER HAMILTON LLP, ONE MELLON CENTER, 50TH FLOOR, 500 GRANT STREET, PITTSBURGH, PA, 15219, US

(73) Assignee: COACTIVE TECHNOLOGIES, INC., Greenwich, CT (US)

(21) Appl. No.: 12/600,815

(22) PCT Filed: May 14, 2008
(86) PCT No.: PCT/EP08/03853

§ 371 Date: May 11, 2010

(30) Foreign Application Priority Data
May 18, 2007 (DE) 102007024249.4-42

(51) Int. Cl. G01B 7/30

(52) U.S. Cl. 324/207.25

(57) ABSTRACT

A device for detecting an actuation angle of an element rotatable or pivotable about a shaft of the mentioned type. The device includes a sensor unit configured to emit an electrical signal depending on an angle of rotation and including an annular permanent magnet non-movably connected to the rotatable or pivotable element. The sensor includes a stationary Hall sensor array having two or more Hall sensors disposed at an angular distance about the annular permanent magnet, wherein an individual Hall sensor located in a linear zone defined by the movement of the rotatable or pivotable element is selected by a microcontroller according to a current position of the rotatable or pivotable element.

### RELATED APPLICATION AND CLAIM OF PRIORITY

This application claims the priority benefit of P.C.T. Application no. PCT/EP2008/003853 filed May 14, 2008, which is hereby incorporated by reference in its entirety; which claims priority to German Patent Application No. 10 2007 024 249.4-42 filed May 18, 2007.

Not Applicable

### BACKGROUND

The present disclosure relates to a device for detecting an actuation angle of more than 90° of an element rotatable or pivotable about a shaft.

As shown in German Patent No. 101 33 492 A 1, a device for detecting an actuation angle of an element rotatable or pivotable about a shaft in the form of a foot pedal is known. In this device, one or more permanent magnets are associated with two Hall sensors of a Hall sensor array. The Hall sensor array functions such that the pivoting movement of a foot pedal in the one direction is identified by a first Hall sensor as a positive angular movement and

In this known device, thus, only a limited angular range of ±<90° can be detected and evaluated. For certain applications this is not sufficient.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “coil” is a reference to one or more coils and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

It is an object of the present invention to provide a device for detecting an actuation angle of an element rotatable or pivotable about a shaft of the type as described in the

In order to solve this object, in a device for detecting an actuation angle of an element rotatable or pivotable about a shaft of the mentioned type. The device includes a sensor unit configured to emit an electrical signal depending on an angle of rotation and including an annular permanent magnet non-movably connected to the rotatable or pivotable element. The sensor includes a stationary Hall sensor array having two or more Hall sensors disposed at an angular distance about the annular permanent magnet, wherein an individual Hall sensor located in a linear zone defined by the movement of the rotatable or pivotable element is selected by a microcontroller according to a current position of the rotatable or pivotable element.

In using this device, it is possible to evaluate an angle of more than 180° as several sensors are distributed about the circumference of the annular permanent magnet. Therein, the signal of the Hall sensor located in the most advantageous zone of as defined by the movement of the rotatable or pintable element is respectively used, wherein the microcontroller or the electronic circuit thereof determines which one of the Hall sensors in a certain angular range is selected and classified as active. By the arrangement of three instead of two Hall sensors, moreover, it is possible to evaluate a complete rotation of 360° of the rotatable element. Moreover, a further sensor may be disposed if the evaluation is to be redundant.

Further details of the invention are apparent from the following description, in which the invention is described and explained in more detail by way of the embodiments illustrated in the figures.

### BRIEF DESCRIPTION OF THE DRAWINGS

Aspects, features, benefits and advantages of the present invention will be apparent with regard to the following description and accompanying drawings, of which:

FIG. 1 illustrates an exemplary device having two sensors for detecting an actuation angle of more than 180° according to an embodiment;

FIG. 2 illustrates a sectional view of the device of FIG. 1 along the line II-II according to an embodiment;

FIG. 3 illustrates an enlarged cutout representation according to the circle III of FIG. 1 according to an embodiment;

FIG. 4 illustrates an enlarged cutout representation according to the circle IV of FIG. 2, and

FIG. 5 illustrates an exemplary diagram of an analog-digital converted signal voltage of the two sensors according to an embodiment.

### DETAILED DESCRIPTION

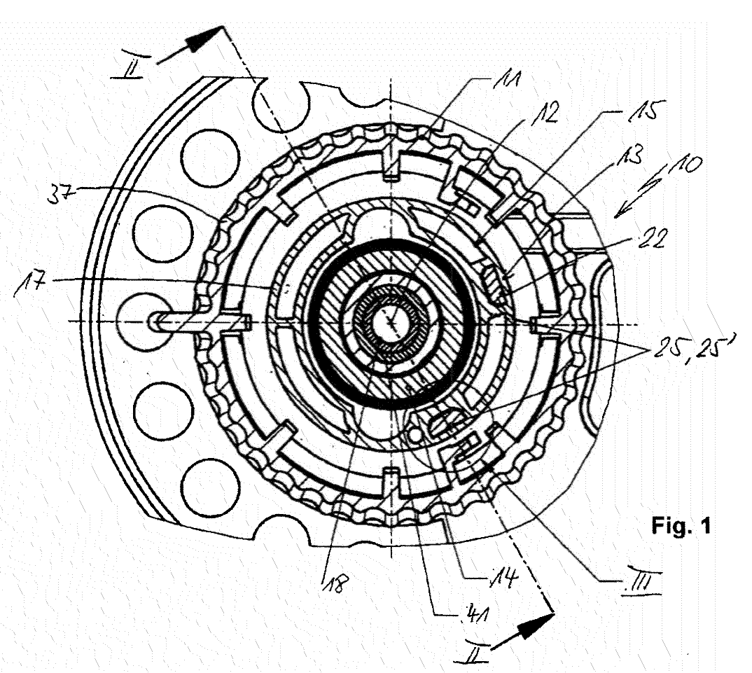

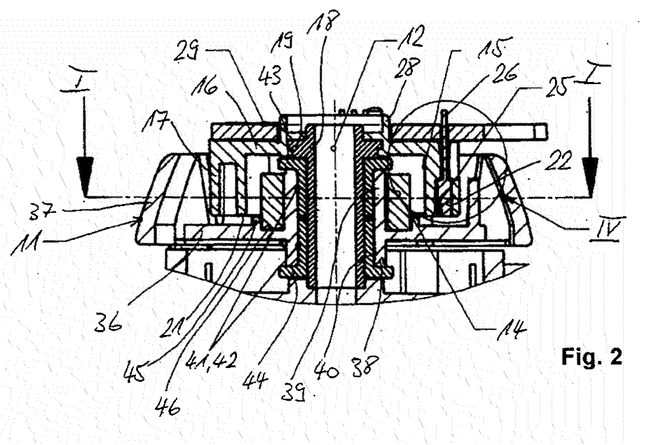

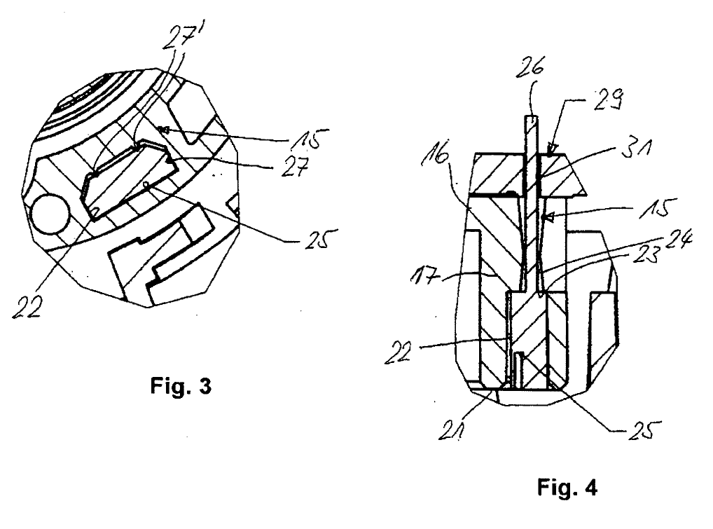

The exemplary device 10 illustrated in the FIGS. 1-4 may serve as an armrest on tractors or as an output shaft for coupling agricultural machines to tractors. The device 10 may be configured to adjust and detect an actuation angle of more than 90°, or 180° and greater, in the same rotational direction of an input element 11 about a shaft 12. The adjustment and detection of the actuation angle may be effected via a magnetic field sensor unit composed of a Hall sensor array 13 and an annular permanent magnet 14, thereby driving or adjusting the component to be operated and adjustable in its actuation angle in a non-illustrated manner. While the unique annular permanent magnet 14 may be disposed on the wheel-shaped input element 11, the Hall sensor array 13 may be retained on a sensor retainer 15 with respect to which the wheel-shaped input element 11 is rotatable concentrically by an angle of >90° or of >180° (in the illustrated embodiment of 210° to 220°) in the same direction. In one possible embodiment, the wheel shaped element 11 may be rotatable up to 360°.

The inverted, approximately pot-shaped sensor retainer 15 may be integrally formed of plastic, or other similar material, having a bottom 16 and a circumferential jacket 17. The bottom 16 of the sensor retainer 15 may be centrally penetrated by a hollow metallic shaft 18 and rotationally fixedly connected to the shaft 18. A radial flange 19 of the hollow shaft 18 may be insert-molded with the bottom 16. Thereby, exact positioning of the hollow shaft 18, which is preferably made of steel, to the sensor retainer 15 may be achieved.

In an exemplary embodiment, the jacket 17 of the sensor retainer 15 may have two recesses 22 disposed at an angular distance of slightly less than 90°, e.g., 80°, to each other and emanating from an axial lateral surface 21: The axial lateral surface 21 may transition through a ring switch surface 23 into a lower-diameter through-bore 24 in the axial direction. A single Hall sensor 25 or 25′ of the Hall sensor array 13 may be individually inserted in these recesses 22 or chambers, electrical contact pins 26 of which may penetrate the through-bore 24 and protrude from the bottom 16 of the sensor retainer 15. Each Hall sensor 25, 25′ may be supported in the recess 22 by one or more crimping ribs 27, 27′ at two mutually perpendicular lateral surfaces, between which the Hall sensor 25, 25′ may be retained. Thereby, the Hall sensor 25, 25′ may be restrained firmly into a corner of the chamber 22. In an exemplary embodiment, a short side of the chamber 22 may have a single crimping rib 27, while a long side extending perpendicularly thereto may have two spaced crimping ribs 27′. It is understood that the number of the crimping ribs 27, 27′ or the cross-section of the chamber 22 may be configured in another manner depending on the configuration of the chamber 22 and the number of Hall sensors 25, 25′ being used.

At the bottom 16 of the sensor retainer 15, a printed circuit board or board 29 may be located facing away from the chambers 22, which is centrally disposed about an axial annular flange of the bottom 16. The board 29 may be fixedly connected to the bottom 16. The contact pins 26 of the Hall sensor 25, 25′ may be plugged through electrically conducting bores 31 of the board 29 and soldered. Thereby, the electrical connection of the Hall sensors 25, 25′ may be achieved through the board 29.

Although only two Hall sensors 25 and 25′ are disposed at an angular distance of slightly less than 90°, e.g., 80°, in an exemplary embodiment, it is understood that three or four Hall sensors 25 may be disposed or provided about the circumference of the lateral surface 21 in a corresponding plurality of chambers 22. With two Hall sensors 25, 25′ according to an exemplary embodiment, an angular range of about 210° to 220° may be achieved. With three Hall sensors, an angular range of 360° may be achieved. A redundant evaluation of the actuation angle of 360° may be achieved by four of more Hall sensors 25.

The wheel-shaped input element 11 may have a bottom 36 and a handle 37 integrally made of plastic or other similar material. The handle 37 may be formed in the manner of a lateral surface tapering conically, curved from the bottom to the top, which is open for gripping around the sensor retainer 15 in a manner facing it.

The bottom 36 may integrally have an inner sleeve 38 axially protruding to both sides of the bottom 36, wherein the sleeve section 39 located within the handle 37 may be longer than the sleeve section 40 facing away from the handle 37. The centric inner sleeve 38 may be surrounded by two slide bushings 41 and 42 on its inner surface. The two identical slide

The permanent annular magnet 14 may be disposed and retained between the circumferential surface of the inner sleeve 38 facing away from the slide bushings 41, 42 and a radially outer annular flange 45 axially protruding from the bottom. Therein, the annular permanent magnet 14 may be inserted in an annular recess of the bottom 36 and adhered therein in centered manner. The annular magnet may extend up to the vicinity of the annular end surface of the upper longer sleeve section 39.

The input element 11 may be rotatably supported on the hollow shaft 18 with clearance with the two slide bushings 41 and 42. This may be achieved in that the two slide bushings 41 and 42 are constituted by sintered bronze bushings or other similar bushings, which result in this clearance support in combination with the hollow shaft 18 of steel or other suitable material.

By the axial engagement of input element 11 and sensor retainer 15 and the corresponding arrangement of permanent magnet 14 and Hall sensors 25, 25′, an association both in radial and in axial direction exists in that the Hall sensors 25, 25′ may be disposed radially in a fixed distance and axially approximately at central level of the annular permanent magnet 14.

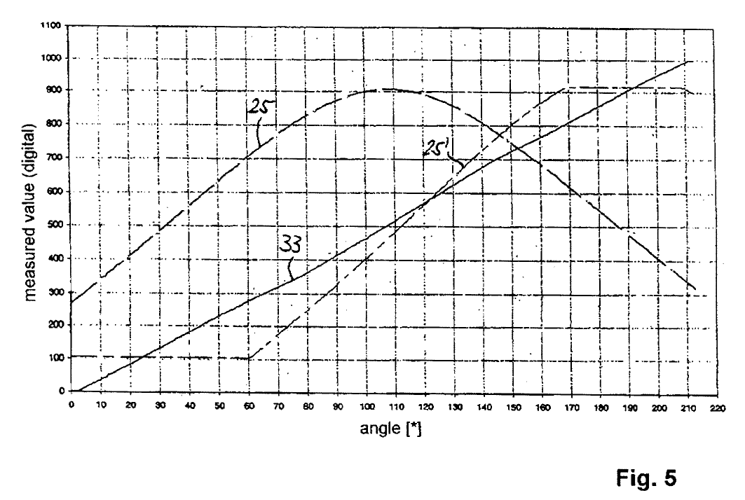

In a non-illustrated embodiment, a microcontroller may be provided on the board 29 and configured to select which of the Hall sensor 25 or 25′ is respectively most advantageous in position to detect the location of the annular magnet 14 based upon the current position of the wheel-shaped input element 11 in order to detect the concerned actuation angle. Thereby, it may be determined which one of the two Hall sensors 25, 25′ is or is to be respectively active. That is, according to the illustration of the characteristics (digitally converted signal voltage depending on the actuation angle) of the sensors 25 (dashed) and 25′ (dot-dashed) in FIG. 5, that Hall sensor 25, 25′ may be respectively consecutively selected by the microcontroller, the characteristic 33 of which (in solid line) may be in the linear region or zone at the corresponding actuation angle such that the resulting overall or output characteristic 33 composed thereof may be linear in the actuation angle range of here about 210° to 220°. If it is required, by toggling to or from the respective Hall sensor 25, 25′, the respectively most linear behavior may also be detected therein. For example, the best or optimized linearity of the characteristic 33 may result over the angular range of 210° to 220° at an angular distance of the two Hall sensors 25 and 25′ of 80°.

Additionally, the microcontroller may avoid a jump present in the output characteristic in the transition regions caused by switching points from one 25 to the next Hall sensor 25′ or vice versa. It is understood that this is also true at an actuation angle of 360° in case of three or four Hall sensors.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1-20. (canceled)

21. A device for detecting an actuation angle of more than 180° of an element rotatable or pivotable about a shaft comprising:
a sensor unit configured to emit an electrical signal depending on an angle of rotation and including an annular permanent magnet non-movably connected to the rotatable or pivotable element, characterized in that the sensor device comprises:
a stationary Hall sensor array having two or more Hall sensors disposed at an angular distance about the annular permanent magnet, wherein an individual Hall sensor located in a linear zone defined by the movement of the rotatable or pivotable element is selected by a microcontroller according to a current position of the rotatable or pivotable element.

22. The device of claim 21, wherein the selected Hall sensor which lies within the linear zone is selected consecutively by said microcontroller such that a resulting overall or output remains linear during an actuation angle range from 0° to 360°.

23. The device of claim 22, wherein a maximum actuation angle range from about 210° to 220° is selected between any linear characteristics of two Hall sensors.

24. The device of claim 21, wherein the annular permanent magnet is diametrically magnetized.

25. The device of claim 21, wherein the sensor array comprises Hall sensors which are disposed such that they are uniformly angularly distributed about the annular permanent magnet.

26. The device of claim 25, wherein the sensor array comprises two Hall sensors spaced apart by an angle of 80°.

27. The device of claim 21, wherein the rotatable or pivotable element is supported on the shaft by a slide bushing, wherein the slide bushing is axially divided.

28. The device of claim 27, wherein the shaft is made of steel and the slide bushing is made of bronze.

29. The device of claim 28, wherein the rotatable or pivotable element contains the annular permanent magnet.

30. The device of claim 29, wherein the permanent magnet is adhesively retained on the rotatable or pivotable element.

31. The device of claim 30, wherein the rotatable or pivotable element comprises an annular flange, the flange comprising:
a radially inner side which is connected to the slide bushing, and a radially outer side on which the annular permanent magnet is retained in a centering manner.

32. The device of claim 21, wherein the rotatable or pivotable element is formed as an input wheel.

33. The device of claim 21, further comprising a sensor retainer comprising chambers configured to receive the Hall sensors at an irregular angular distance.

34. The device of claim 33, wherein an individual. Hall sensor is retained in position in a respective chamber of the sensor retainer.

35. The device of claim 34, further comprising crimping ribs in the chamber on at least two sides.

36. The device of claim 34, wherein the sensor retainer is fixedly connected to the shaft.

37. The device of claim 36, further comprising a flange on the shaft, wherein the flange is insert-molded with the sensor retainer.

38. The device of claim 34, wherein the sensor retainer is hood-shaped and configured to radially engage between the annular permanent magnet and an outer circumference rim of the rotatable or pivotable element or input wheel, wherein a lateral surface of the sensor retainer includes the chambers.

39. The device of claim 21, further comprising a printed circuit board on which the Hall sensors are retained by a plurality of electrical terminals.

40. The device of claim 39, wherein the plurality of electrical terminals are guided by the sensor retainer to the printed circuit board.
